(19) United States
(12) Patent Application Publication
(10) Pub. No.: US 2025/0291577 A1
(43) Pub. Date: Sep. 18, 2025

(54) METHODS AND SYSTEMS FOR ADAPTING A CODE BASE OF AN APPLICATION AND UPDATING AN APPLICATION IN A DISTRIBUTED ENVIRONMENT

(71) Applicant: Siemens Healthineers AG, Forchheim (DE)

(72) Inventors: Chetan H D, Bengaluru (IN); Varghese KOLLERATHU, Bengaluru (IN); Rahul RAMESH, Bengaluru (IN); Abhinandan TEJANI, Bangalore (IN); Vineet VINAY BHOMBORE, Bengaluru (IN)

(73) Assignee: Siemens Healthineers AG, Forchheim (DE)

(21) Appl. No.: 19/081,282

(22) Filed: Mar. 17, 2025

(30) Foreign Application Priority Data
Mar. 18, 2024 (DE) 10 2024 202 503.8

(51) Int. Cl. G06F 8/65

(52) U.S. Cl. CPC G06F 8/65

(57) ABSTRACT

A method for adapting a code base of an application including a plurality of features and being deployed in a distributed environment including a service center and one or more local sites, comprises: obtaining, at the service center, usage information indicating a usage of one or more of the plurality of features of the application operated at at least one of the one or more local sites; obtaining, at the service center, a code base of the application; generating, at the service center, an adapted code base of the application from the code base and based on the usage information; and providing the adapted code base.

### CROSS-REFERENCE TO RELATED APPLICATION(S)

The present application claims priority under 35 U.S.C. § 119 to German Patent Application No. 10 2024 202 503.8, filed Mar. 18, 2024, the entire contents of which is incorporated herein by reference.

### FIELD

Embodiments of the present invention concern methods and systems for adapting a software release plan and in particular a code base of an application according to a usage pattern of the application in a distributed environment. In particular, embodiments of the present invention concern methods and systems for monitoring the usage of features of the application at customer sites and centrally adapting the release strategy and the code base using the information about the usage. In particular, embodiments of the present invention concern concepts for identifying obsolete features based on the usage and for removing those features from the software release plan.

### BACKGROUND

Administrating complex computer program products or applications in a distributed environment is a challenging problem. This is because the applications are usually managed by a central service provider and rolled out to a plethora of customer sites at the same time. As a consequence, the application has to fulfill the needs of many different customers which may have vastly different requirements. Further, also the applications themselves add another layer of complexity: in large software or computer program products, e.g., in applications in the field of reading and analyzing medical images, usually many features get updated or new features get developed with every release of the computer program product. As a consequence, there are almost always features which became obsolete in the sense that they are no longer relevant for the product as whole. This may lead to features which are further maintained in the release cycles of the application despite of the fact that they are no longer used in a significant amount.

There may be several reasons as to why a certain feature is not used. For instance, a functionality of a feature has been taken over by other features which are more readily usable at a customer site. Moreover, a feature may have been superseded altogether by a new feature. On the other hand, customers may be unaware of a (new) feature. One reason for this may be that customers are usually busy or try to stick to their familiar workflows, without adopting the latest improvements. In addition, a feature may not be used because the feature did not improve the customers' productivity level. Another reason may be that some features remain in feature toggle without getting activated and are therefore completely unused at customer sites.

Maintaining obsolete features in the release cycles of a computer program product has several disadvantages. To begin with, this leads to an ever growing release package which entails increased development and maintenance costs at the side of the provider. In addition, it may become increasingly challenging to port the application to an updated version. At the side of the customer, this may lead to prolonged downtimes if the application is updated. Moreover, large packages sizes and feature sets may adversely affect the system's performance, if these features are preloaded as a service. Moreover, any code may pose security threats. Keeping code related to obsolete features may increase the security risk.

### SUMMARY

It is an object of one or more embodiments of the present invention to provide systems and methods for improving the release cycle management of complex applications. In particular, it is an object of one or more embodiments of the present invention to provide systems and methods which enable an improved adaptation of the release package of an application and, in particular, the code base of the application, in order to render the distribution and deployment of the application at the local customer sites more efficient.

At least this object is solved by a method for adapting a code base of an application, a method for providing an update-package for updating an application, corresponding systems, computer-program products, and computer-readable storage media according to the main claims. Alternative and/or preferred embodiments are subject of the dependent claims.

In the following, the technical solution according to embodiments of the present invention is described with respect to the claimed apparatuses as well as with respect to the claimed methods. Features, advantages, or alternative embodiments described herein can likewise be assigned to other claimed objects and vice versa. In other words, claims addressing the inventive method can be improved by features described or claimed with respect to the apparatuses. In this case, e.g., functional features of the method are embodied by objective units or elements of the apparatus.

According to an aspect, a computer-implemented method for adapting a code base of an application is provided. The application comprises a plurality of features. Further, the application is deployed in a distributed environment comprising a service center administrating the application and one or more local sites operating the application. The method comprises a plurality of steps. One step is directed to obtain, at the service center, a usage information indicating a usage of one or more of the features of the application operated by at least one of the one or more local sites. Another step is directed to obtain, at the service center, the code base of the application. Another step is directed to generate, at the service center, an adapted code base of the application from the code base and based on the usage information. Another step is directed to provide the adapted code base.

An application may be seen as a computer program product. The application may comprise program elements which induce a computing unit at a local site to make available and execute the features of the application at the local site. The application may, for example, comprise a computer program or comprise another element next to the computer program as such. This other element can be hardware, e.g., a memory device, on which the computer program is stored, a hardware key for using the computer program and the like, and/or software, e.g., a documentation or a software key for using the computer program. The application may further comprise development material, a runtime system and/or databases or libraries. The application may be distributed among several computing instances at the local site and/or the service center.

The code base may comprise the source code of the application. The code base may comprise a collection of text written using a human-readable programming language. The code base may be transformed by an assembler or compiler at the service center into binary machine code that can be executed by a computing unit at a local site. The machine code is also referred to as executable. The executable is configured to cause a computing device at a local site to enable features according to encoded instructions. According to some examples, the code base is not forwarded to the local sites.

A feature may relate to a function of the application which the application can execute, in particular, at the local sites. The function may be configured to execute the feature responsive to a request input at the local sites. For instance, the request may be input by a user at the local site. According to some examples, the feature may relate to a data processing function configured to process input data such as image data to provide a certain output such as a measurement value or a representation of the image data for displaying to a user.

The service center may comprise a central server unit which is configured to administrate and/or maintain and/or distribute the application. For instance, the service center may comprise a web server. Further, the service center may comprise a cloud server or a local server. The service center may be in data communication with one or more local sites. The service center may be configured to administrate the code base, to generate executables based on the code base and to transmit executables of the application to the local sites. Administrating the code base may comprise version control capabilities for editing or adapting the code base. Version control may happen automatically or semi-automatically, e.g., based on an input of a developer. In this regard, the service center may comprise one or more user interfaces configured for allowing developers to make changes to the code base. The service center may further be configured to evaluate the usage patterns of the application at the local sites. The service center may comprise an interface unit for facilitating data communication with the local sites, for instance via internet connection.

The local sites may be conceived as clients or customer units. The local sites may be configured for receiving the application (in particular, an executable of the application) and execute the application. Specifically, the local sites may be configured to execute one or more features of the application responsive to a request input by a user at the local site. The local sites may, in particular, comprise a local computer network comprising one or more computing units. The local sites may, for instance, relate to an organization in which the application is to be deployed. In particular, the local sites may relate to healthcare environments or organizations, or facilities such as hospitals, laboratories, practices, universities, or associations of one or more of the previously mentioned. According to some examples, the service center is located outside of the local sites and serves one or more of the local sites from the outside.

The usage information may comprise an indication of the number of times a feature has been used in one or more of the local sites. The usage information may indicate the number of times a feature has been used over a predetermined period of time, e.g., since the last update of the application at the local site or the first deployment of the application at the local site, or within a fixed period of time. In other words, the usage information may indicate a usage frequency of one or more features of the application. According to some examples, the usage information may respectively comprise a usage frequency for all of the features of the application. The usage information may comprise a collection of real numbers indicating for one or more features (in particular: for all features) of the application how often the feature has been used by a specific local site, by a plurality of the local sites, or within the entire distributed environment.

According to some examples, adapting the code base comprises changing the code base and, in particular, removing elements from the code base and/or changing and/or adding elements within the code base. This may involve making changes to the text in the code base, such as removing text elements and/or re-writing text elements and/or adding text elements. According to some examples, adapting the code base may comprise trimming or truncating the code base. According to some examples, the adapted code base may comprise (or encode) fewer features than the code base. In other words, compiling the adapted code base may lead to a software build of the application with fewer features than a software build based on the initial, not yet adapted code base.

Providing may comprise providing the code base for further processing at the service center. This may comprise compiling the code base or parts of the code base so as to generate one or more executables. In particular, the one or more executables may be part of an update package to be distributed in the distributed environment. Further, providing may mean archiving the adapted code base as a version of the application.

With the above method, the code base of an application is automatically adapted according to the actual usage of the features of the application in the distributed environment. This may render the maintenance and the release management of the application more efficient as this may allow for removing unnecessary elements from the code base.

According to another aspect, a computer-implemented method for adapting a software release product of an application is provided. The application comprises a plurality of features and is deployed in a distributed environment comprising a service center administrating the application and one or more local sites operating the application. The method comprises a plurality of steps. One step is directed to obtain, at the service center, a usage information indicating a usage of one or more of the features of the application operated by at least one of the one or more local sites. Another step is directed to obtain, at the service center, the software release product of the application. Another step is directed to generate, at the service center, an adapted software release product of the application from the code base and based on and the usage information. Another step is directed to provide the adapted software release product.

The software release product comprises the code base of the application according to the certain release or version. In addition to the code base, the software release product may comprise a documentation of the application according to the release or version. Further, the software release product may comprise of-the-shelf-(OTS-) software. OTS-software is embedded in the application as is and typically not managed by the service center. Thus, adapting the software release product may mean adapting one or more of the other components besides the code base such as the documentation or the OTS-software plug-ins.

According to some examples, the method comprises receiving update instructions for updating the application for a first version to a second version, applying the update instructions to the adapted code base so as to generate an updated version of the adapted code base, and providing the updated version of the adapted code base.

In other words, the update is performed based on the already adapted code base. This has the advantage that unnecessary elements of the code base do not need to be considered when updating the application from the first to the second version.

According to an aspect, the step of obtaining the usage information comprises receiving individual usage information from a plurality of local sites, in particular from all of the local sites, the individual usage information respectively indicating the usage of one or more of the features of the application at the respective local site, and aggregating the individual usage information so as to obtain the usage information.

With that, the usage pattern in the entire distributed environment may be collected and considered for adapting the code base. This may ensure that a sufficiently complete picture of the usage is generated. In particular, this may rule out removing a feature which is still in use within some of the local sites. An aggregation may comprise adding the usage numbers received from the local sites.

According to some examples, the application is operated in a first version at the one or more local sites, and the method further comprises generating an update package for updating the application from the first version to a second version based on the adapted code base and transmitting the update package from the service center to the one or more local sites.

Another word for update package may be software build (e.g., for updating the application from the first to the second version). The update package may comprise one or more executables generated based on the code base. Accordingly, generating the update package may comprise compiling at least parts of the code base.

According to some examples, the step of generating the update package comprises updating the adapted code base from the first version to the second version so as to generate an updated version of the code base and generating the update package based on the updated version of the adapted code base.

This update path has the advantage that the update package is generated based on the already adapted code base. This has the advantage that the update package only comprises those parts of the application which are still necessary according to the usage pattern of the application. This may reduce the size of the update package which may reduce the downtime during an update at the local site and increase the performance and stability of the application at runtime.

According to some examples, the method further comprises obtaining a (individual) usage information of a particular local site of the one or more local sites, generating an adapted update package based on the usage information of the particular local site, and forwarding the adapted update package to the particular local site.

Generating the adapted update package may comprise compiling the adapted code base based on the particular usage information specifically for the particular local site.

In other words, in addition to optimizing the (global) code base based on the usage information, the individual usage information of individual sites may further be used for providing dedicated update packages for the respective individual sites. For instance, the update package may comprise less features than the adapted code base. This may further facilitate the update process and increase the performance and stability of the application at the individual local site.

According to some examples, the step of generating the adapted code base comprises identifying, at the service center, one or more obsolete features of the plurality of features based on the usage information and removing and/or deactivating elements from the code base relating to the one or more obsolete features so as to generate the adapted code base.

Elements of the code base may relate to sections of the code such as text passages of the code base.

According to some examples, the usage information comprises one or more usage numbers respectively indicating the usage of one of the one or more features, and the step of identifying the one or more obsolete features may comprise comparing the one or more usage numbers to a predetermined threshold.

According to some examples, the threshold may be zero (for identifying the features which are not used at all). According to other examples, the threshold may be non-zero (for also identifying features which are seldomly used).

According to some examples, the step of identifying the one or more obsolete features may comprise determining, for one or more of the features, if they can be substituted by one or more other features of the application. In particular, this step of determining may be performed for those features the usage number of which is non-zero and/or below the pre-determined threshold.

By identifying obsolete features, the code base can be efficiently pruned. By identifying substitute features also seldomly used features and/or duplicate features can be removed.

According to an aspect, the step of generating the adapted code base further comprises identifying one or more code segments in the code base corresponding to the obsolete features and determining a dependency information indicating a dependency of the one or more code segments from other code segments in the code base, wherein the step of removing and/or deactivating is based on the dependency information.

In particular, the step of removing and/or deactivating comprises identifying elements to be removed and/or deactivated based on the dependency information.

According to some examples, the dependency information may be determined based on the code base.

Code segments may be sections of the code base which directly relate to a feature. In most cases it is not possible to simply remove these code segments because other features (which are to be retained) may also depend on the code segments. By obtaining and utilizing the dependency information, those elements of the code base can be identified which can actually be removed. The elements which are removed or otherwise altered may comprise less code (or text) than the segments corresponding to the obsolete features.

According to some examples, the method comprises obtaining a versioning information of the application linking features to code segments and identifying the one or more code segments based on the versioning information and/or determining the dependency information based on the versioning information.

The versioning information may comprise natural language text, e.g., in the form of a (separate) release note or documentation of the application and/or a manifest file and/or comments in the code base.

According to an aspect, the step of determining the dependency information comprises generating a dependency graph of code segments in the code base and the step of removing and/or deactivating comprises applying a graph cut algorithm to the dependency graph in view of the identified one or more code segments so as to identify the elements to be removed and/or deactivated.

A dependency graph may be a directed graph in a mathematical sense. The dependency graph may comprise a summary of the code segments comprised in the code base. It may show any dependencies a particular code segment depends on and dependents that depend on the particular code segment. Further, the usage information may be injected in the dependency graph, e.g., by including the usage number for each code segment.

According to some examples, the graph cut algorithm may implement an optimization method capable of finding an optimum regarding a specific problem, in this case, the minimization of code segments with zero or low (in the sense of lower than a predetermined threshold) usage numbers. Specifically, according to some examples, the graph cut algorithm may implement the max-flow min-cut theorem according to which determining the minimum cut over a graph representing a flow network or graph is equivalent to computing the maximum flow over the network or graph.

The inventors have recognized that generating a dependency graph enables to automatically handle complex dependencies in the code base of complex applications. In particular, this enables using graph-based optimization schemes allowing for a swift optimization of the dependency graph and, thus, the code base.

According to an aspect, the step of generating the adapted code base comprises providing a large language model configured to identify elements in the code base of an application relating to a feature of the application and/or to remove and/or deactivate elements from the code base of an application relating to a feature of the application and applying the large language model to the code base based on one or more of the obsolete features so as to remove and/or deactivate elements from the code base relating to the one or more obsolete features.

According to some examples, the large langue model may be used to provide the dependency information and/or the dependency graph. According to other examples, the large language model may also be used differently, e.g., in a way that the large language model is directly input with prompt to remove a certain feature from the code base (without affecting other features).

A large language model may rely on a transformer network. A large language model is a language model that stands out for its size. The artificial neural networks with which they are built can contain tens of millions to billions of weights and are pre-trained with self-supervised learning and semi-supervised learning. Examples of large language models that can be used to adapt a code base as herein described are the models of the GPT series (GPT-3.5 and GPT-4; used in ChatGPT), the LLaMa series, PaLM (used in Google Bard), BLOOM, Ernie 3.0 Titan, or Claude.

An advantage of large language models is that due to their transformer architecture with the inbuilt attention mechanism, far-reaching dependencies can be efficiently accounted for in the input data such as the code base.

According to an as aspect, the method further comprises obtaining, at the service center, a documentation of the application comprising natural language text describing the one or more features according to the code base, adapting, at the service center, the documentation so as to generate an adapted documentation according to the adapted code base, and providing the adapted documentation.

The documentation may be a text document, e.g., in the form of a manual of the application, The documentation may comprise a description of one or more features of the application. The documentation may be an internal documentation, e.g., for developer environment at the service center. Further, the documentation may be a documentation to be forwarded to the local sites. According to some examples, the step of providing comprises transmitting the documentation to the local site. According to some examples, the step of adapting the documentation comprises removing test passages from the documentation relating to the one or more obsolete features so as to generate the adapted documentation. Further, according to some examples, the step of adapting the documentation comprises applying a large language model to the documentation, in particular, based on one or more of the obsolete features so as to remove elements from the documentation relating to the one or more obsolete features.

By automatically adapting the documentation to the adapted code base, the release management of the application may be rendered more efficient.

According to some examples, the method further comprises obtaining, at the service center, a requirement specification identifying one or more required features, wherein, in the step of generating the adapted code base, the adapted code base is additionally generated based on the requirement specification.

The requirement specification may comprise an indication of features which must not be removed, e.g., because of legal or regulatory obligations, tender requirements, service level agreements and so forth. Accordingly, the step of adapting may comprise checking, based on the requirement specification whether or not the one or more obsolete features may be removed. The requirement specification may be a list of required features. According to some alternatives, the requirement specification may comprise one or more high-level text documents such as contracts, tender offers, and the like. According to some examples, the step of obtaining the requirement specification comprises receiving the requirement specification from the at least one local site. Alternatively, the requirement specification may be stored at the service center.

The requirement specification may comprise additional restrictions regarding the removal of unused features. By considering the requirement specification, it can be ensured that the adapted code base is still compliant.

According to some examples, the method may further comprise identifying, at the service center, one or more obsolete features which should not be removed from the code base according to the requirement specification and providing a notification from the service center to the at least one local site indicating the identified obsolete features which should not be removed.

With that, the local site can be notified of features which are required but are only seldom or never used. This enables the local site to adapt the internal processes in order to better use (or retire, as the case may be) some of the required features, for instance.

According to some examples, the step of identifying one or more required features may comprise applying a large language model to the requirement definition with the task/prompt to identify the required features.

According to an aspect, the application is configured for handling medical data (e.g., of a patient) and the features respectively relate to functions for processing the medical data.

The medical data may comprise image data and non-image data. For example, non-image data may include one or more medical reports, for example from radiology, pathology, laboratory, or other disciplines. Further, the non-image data may include longitudinal data that includes one or more medical values of the patient and/or elements from the patient's disease history. This can include laboratory data, vital signs and/or other patient-related measurements or examinations.

The functions may generally be configured to process the medical data in order to derive one or more processing results for deriving a medical diagnosis of the patient. For instance, the functions may be configured to extract measurement values, trends, facts, or circumstances of the patient case.

According to an aspect, the medical data comprises medical image data and the features respectively relate to functions for processing the medical image data.

According to some examples, the medical image data comprises a plurality of medical image data sets respectively showing a body part of a patient.

The medical image data may relate to a medical image study. The medical image data may relate to three-dimensional data sets providing three dimensions in space or two dimensions in space and one dimension in time, to two-dimensional data sets providing two dimensions in space, and/or to four-dimensional data sets providing three dimensions in space and one dimension in time.

The medical image data may depict a body part of a patient in the sense that it contains three-dimensional image data of the patient's body part. The medical image data may be representative of an image volume. The patient's body part may be comprised in the image volume.

The medical image data comprises data, for example, in the form of a two- or three-dimensional array of pixels or voxels. Such arrays of pixels or voxels may be representative of intensity, absorption, or other parameters as a function of three-dimensional position, and may, for example, be obtained by suitable processing of measurement signals obtained by a medical imaging modality.

A medical imaging modality corresponds to a system used to generate or produce medical image data. For example, a medical imaging modality may be a computed tomography system (CT system), a magnetic resonance system (MR system), an angiography (or C-arm X-ray) system, a positron-emission tomography system (PET system), an ultrasound imaging system or the like. Specifically, computed tomography is a widely used imaging method and makes use of “hard” X-rays produced and detected by a specially rotating instrument.

The medical image data may comprise a plurality of images or image slices. The slices may respectively show a cross-sectional view of the image volume. The slices may comprise a two-dimensional array of pixels or voxels as image data. The arrangement of slices in the medical image data may be determined by the imaging modality or by any post-processing scheme used.

Further, the medical image data may be a two-dimensional pathology image data set, i.e., a so-called whole-slide image, depicting a tissue section of a patient.

According to some examples, the medical image data may have been acquired at the local site.

The medical image data may be stored in a standard image format such as the Digital Imaging and Communications in Medicine (DICOM) format and in a memory or computer storage system at the local site such as a Picture Archiving and Communication System (PACS). Whenever DICOM is mentioned herein, it shall be understood that this refers to the “Digital Imaging and Communications in Medicine” (DICOM) standard, for example according to the DICOM PS3.1 2020c standard (or any later or earlier version of said standard).

According to some examples the functions may be configured to provide a processing result for diagnosing a patient based on the medical image data, the functions may comprise one or more of: a function for detecting a medical finding, a function for classifying a medical finding, a function for generating a segmentation of the medical image data, a function for extracting a measurement of the medical image, a function for comparing medical image data, a function for generating a representation of the medical image data, in particular, for displaying the medical image data and/or a function for annotating medical image data.

By applying the method to medical (image) data processing, the advantages of the method in particular take effect. This is because applications for reading medical (image) data are complex and typically involve a plurality of features the software release management of which may be complex. At the same time, there are tight regulations regarding the quality and performance of those applications.

According to an aspect, a computer-implemented method for providing an update-package for updating an application comprising a plurality of features from a first version to a second version at a local site in a distributed environment comprising a service center and one or more local sites is provided. The method comprises a plurality of steps. One step is directed to receive, at a service center from at least one of the local sites, a usage information indicating a usage of one or more of the features of the application running in the first version at the at least one local site. Another step is directed to obtain, at the service center, a code base for updating the application from the first version to the second version. Another step is directed to generate, at the service center, the update-package from the code base based on the usage information. Another step is directed to transmit the update-package from the service center to the at least one local site.

Generating the update package may comprise compiling the code base. Accordingly, the update package may comprise one or more executables. Optionally, the update package may additionally comprise a documentation of the update package and, in particular, of the features of the update package.

The update package may be specifically generated for the local site based on its usage information. Accordingly, the update package may be tailormade for the local site with the advantage that features which are only used at some local sites do not need to get distributed to sites not using the features. This may further increase the efficiency of the method.

The above aspect may be combined with other aspects and examples herein described. In particular, the step of obtaining the code base may comprise adapting a code base based on the usage information from one or more (in particular: all) of the local sites as herein described. Accordingly, a two-fold adaptation is possible, with a general “pruning” of the code base followed by configuring a specific update package for the local site.

According to an aspect, the step of generating the update-package comprises identifying, at the service center, one or more obsolete features of the plurality of features based on the usage information and generating the update-package by removing elements from the code base relating to the one or more obsolete features.

In particular, the step of removing may comprise removing the elements for compiling or prior to compiling (only for the particular local site). This may mean keeping certain features under toggle for a particular site.

This may lead to leaner update packages which, in return, reduces the effort for updating the application at the local site.

According to an aspect, the method comprises obtaining, at the service center, a documentation comprising natural language text relating to the application in the second version, and the step of generating the update-package comprises adapting the documentation based on the usage information so as to generate a documentation for the application according to the second version for the local site and including the documentation in the update package.

Adapting the documentation may unfold according to the other aspects and examples as herein described. In particular, the step of adapting the initial documentation comprises removing text passages from the initial documentation relating to the one or more obsolete features.

By providing an adapted documentation specifically for the update package, and therewith, for the local site, the application becomes more readily useable.

According to an aspect, a service center is provided which comprises a computing unit configured to perform the methods according to the aspects and examples herein described.

The computing unit may be realized as a data processing system or as a part of a data processing system. Such a data processing system can, for example, comprise a cloud-computing system, a computer network, a computer, a tablet computer, a smartphone and/or the like. The computing unit can comprise hardware and/or software. The hardware can comprise, for example, one or more processors, one or more memories, and combinations thereof. The one or more memories may store instructions for carrying out the method steps according to embodiments of the present invention. The hardware can be configurable by the software and/or be operable by the software. Generally, all units, sub-units or modules may at least temporarily be in data exchange with each other, e.g., via a network connection or respective interfaces. Consequently, individual units may be located apart from each other. Further, the computing unit may be configured as an edge device.

Further, the service center may comprise an interface unit for interfacing the computing unit with the one or more local sites. The interface unit may comprise an interface for data exchange with one or more local sites, e.g., via the Internet. The interface unit may be further adapted to interface with one or more users of the system, e.g., by displaying the result of the processing to the user (e.g., in a graphical user interface).

The service center may be adapted to implement the methods as herein described in their various aspects and examples. The advantages described in connection with the method aspects and examples may also be realized by the correspondingly configured systems' components.

According to another aspect, an embodiment of the present invention is directed to a non-transitory computer program product comprising program elements which induce a computing unit of a service center for adapting a code base of an application and/or for providing an update-package for updating an application to perform the steps according to one or more of the above method aspects and examples, when the program elements are loaded into a memory of the computing unit.

According to another aspect, an embodiment of the present invention is directed to a non-transitory computer-readable medium on which program elements are stored that are readable and executable by a computing unit of a service center for adapting a code base of an application and/or for providing an update-package for updating an application to perform the steps according to one or more method aspects and examples, when the program elements are executed by the computing unit.

The realization of embodiments of the present invention by a computer program product and/or a non-transitory computer-readable medium has the advantage that already existing providing systems can be easily adapted by software updates in order to work as proposed by embodiments of the present invention.

The computer program product can be, for example, a computer program or comprise another element next to the computer program as such. This other element can be hardware, e.g., a memory device, on which the computer program is stored, a hardware key for using the computer program and the like, and/or software, e.g., a documentation or a software key for using the computer program. The computer program product may further comprise development material, a runtime system and/or databases or libraries. The computer program product may be distributed among several computer instances.

### BRIEF DESCRIPTION OF THE DRAWINGS

Characteristics, features and advantages of the above-described invention, as well as the manner they are achieved, become clearer and more understandable in the light of the following description of embodiments, which will be described in detail with respect to the figures. This following description does not limit the present invention on the contained embodiments. Same components, parts or steps can be labeled with the same reference signs in different figures. In general, the figures are not drawn to scale. In the following:

FIG. 1 schematically depicts an embodiment of a system for adapting a code base of an application and/or for providing an update package for updating the application;

FIG. 2 schematically depicts a method for adapting a code base of an application and/or for providing an update package for updating the application according to an embodiment;

FIG. 3 schematically depicts an exemplary data flow diagram in connection with a method for adapting a code base and/or for providing an update package according to an embodiment;

FIG. 4 schematically depicts optional method steps in a method for adapting a code base of an application according to an embodiment;

FIG. 5 schematically depicts an exemplary data flow diagram in connection with a method for adapting a code base according to an embodiment; and

FIG. 6 schematically depicts a method for providing an update package for updating the application according to an embodiment.

### DETAILED DESCRIPTION

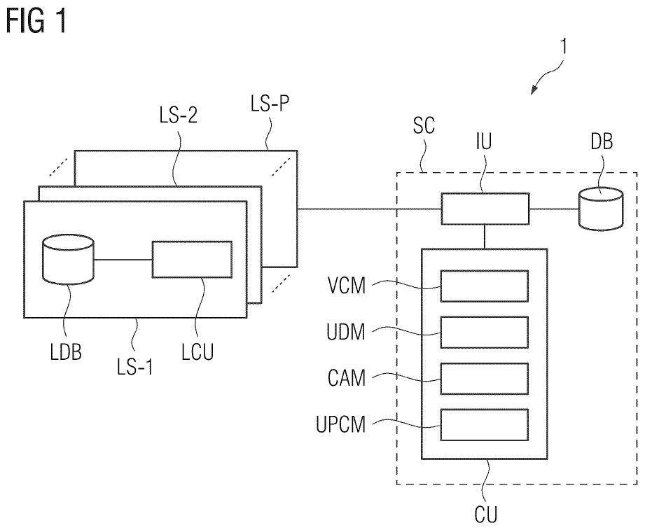

FIG. 1 depicts an example system/distributed environment 1 for adapting a code base CB of an application A comprising a plurality of features F1 . . . FN (i.e., F1, F2, F3, F4, . . . , FN) and/or for providing an update package UP for updating the application A.

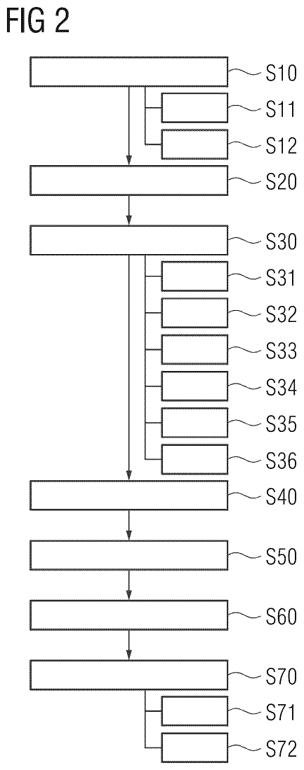

System 1 comprises a service center SC and a plurality of clients respectively located at different local sites LS-1 . . . LS-P (i.e., LS-1, LS-2, . . . , LS-P). The service center SC and the local sites LS-1 . . . LS-P may be interfaced via a network. The service center SC is generally configured to control, coordinate, and steer the updating and roll-out of the application A in the distributed environment 1 according to one or more embodiments, e.g., as further described with reference to FIGS. 2 to 6. The local sites LS-1 . . . LS-P may, for instance, relate to clinical or medical environments, such as hospitals or hospital groups, clinics, or practices.

The application A is centrally administrated by the model service center SC and distributed to the local sites LS-1 . . . LS-P where the application A is deployed. The application A may generally be configured to provide a medical diagnosis based on medical input data. This may include outcome prediction, the detection of findings in medical image data, the annotation of medical images, e.g., in terms of orientations or landmark detection, the generation of medical reports and the like. To perform these tasks, the application A may comprise a plurality of features F1 . . . FN which may implement different data processing routines.

The service center SC may be hosted on a server, which may be a cloud server or a local server. However, the service center SC also may be implemented using any other suitable computing device(s). The service center SC comprises a computing unit CU and an interface unit IU. Further, the service center SC may have access to a database DB which is configured for storing a code base CB of the application A, corresponding documentations DOC, and/or versioning information VI such as a version control history or a feature backlog.

The computing unit CU may comprise one or more processors and a working storage. The one or more processor(s) may include, for example, one or more central processing units (CPUs), graphics processing units (GPUs), and/or other processing devices. Computing unit CU may further comprise a micro-controller or an integrated circuit. Alternatively, computing unit CU may comprise a real or virtual group of computers like a so called ‘cluster’ or ‘cloud’. The working storage may include one or more computer-readable media such as a RAM for temporally loading data, e.g., data from the database DB or data uploaded from the local sites LS-1 . . . LS-P. In particular, this may include individual update information IUI-1 . . . IUI-P (i.e., IUI-1, IUI-2, . . . , IUI-P) from the local sites LS-1 . . . LS-P, respectively indicating how the features F1 . . . FN of the application A are used at the local sites LS-1 . . . LS-P The working storage may further store information accessible by the one or more processors, for performing method steps according to one or more embodiments herein described.

The interface unit IU can include any suitable components for interfacing with one or more networks, including, for example, transmitters, receivers, ports, controllers, or other suitable components. The service center SC may exchange information with one or more local sites LS-1 . . . LS-P via the interface unit IU. Any number of local sites LS-1 . . . LS-P can be connected to service center SC over the interface unit IU.

Computing unit CU may comprise sub-units VCM, UDM, CAM, and UPCM.

Sub-unit VCM may be a version control module configured to administrate the code base CB of the application A and, in particular, for administrating the update and upgrade of the code base CB. The version control module VCM may operate a version control software with which allows developers to create, store, manage and share their contribution to the code base and the versioning information VI. Further, the version control module VCM may include a change management enabling tracking code change sets and a feature backlog both of which may form part of the versioning information VI.

Sub-unit UDM may be conceived as a usage determination module or unit. The usage determination module UDM is configured to collect and aggregate individual update information IUI-1 . . . IUI-P from the local sites LS-1 . . . LS-P to provide a usage information UI of the application A in the distributed environment 1. The usage determination module UDM may further be configured to identify obsolete features OF, for instance by comparing usage numbers of individual features F1 . . . FN against a predetermined threshold TH. Any feature F1 . . . FN the usage of which is below the threshold TH may be regarded as obsolete. Further, usage determination module UDM may be configured to factor-in additional information such as a requirement specification REQ indicating required features F1 . . . FN which may not be deleted.

Sub-unit CAM may be configured as code adaptation module or unit. The code adaptation module CAM may be configured to adapt the code base CB based on the usage information UI. In particular, this may comprise pruning the code base CB from elements E which relate to the obsolete features OF, and which may be removed without affecting the rest of the code base CB. To this end, the code adaptation module CAM may identify dependencies GRPH of code segments SEG in the code base CB and consider these dependencies GRPH when adapting the code base CB. In particular, the code adaptation module CAM may be configured to host and apply, on the dependency information GRPH, a graph cut algorithm GCA for identifying elements to be removed from the code base CB. The result of the processing may be provided as adapted code base CB′.

Sub-unit UPCM is an update package configuration module. It is configured to produce an update package UP based on the adapted code base CB′. The update package UP can be distributed to the local sites LS-1 . . . LS-P. There, it can be used to install the application A and/or bring an already installed application A from a first to a second version. Optionally, the update package configuration module UPCM may further be configured to specifically adapt the update packages UP for the respective local site LS-1 . . . LS-P based on the respective individual update information IUI-1 . . . IUI-P. Moreover, the UPCM may include an adapted documentation DOC′ describing the respective feature set of the build in the update package UP.

The designation of the distinct sub-units VCM, UDM, CAM, UPCM is to be construed by ways of example and not as limiting the disclosure. Accordingly, sub-units VCM, UDM, CAM, UPCM may be integrated to form one single processing unit or can be embodied by computer code segments configured to execute the corresponding method steps running on a processor or the like of computing unit CU. Each sub-unit VCM, UDM, CAM, UPCM may be individually connected to other sub-units and or other components of the system 1 where data exchange is needed to perform the method steps.

Each of the local sites LS-1 . . . LS-P may comprise a local computing unit LCU and a local database LDB. The local database LDB may be realized as a local or spread storage within the premises of the respective local site LS-1 . . . LS-P. The local database LDB may store the local data, in particular, medical data, which is to be processed by the application A. The local database LDB may be part of a hospital information systems (HIS), radiology information systems (RIS), clinical information systems (CIS), laboratory information systems (LIS) and/or cardiovascular information systems (CVIS), picture archiving and communicating system (PACS) or the like.

The local computing unit LCU is configured to execute the application A. In particular, the execution may be responsive to user requests of users at the respective local site LS-1 . . . LS-P. The user requests may be directed to use individual features F1 . . . FN of the application A such as certain image processing functions. At the same time, the local computing unit LCU may be configured to collect usage statistics of the features F1 . . . FN as used in the respective local site LS-1 . . . LS-P. For instance, the local computing unit LCU may count how often a certain feature F1 . . . FN was activated over a given period of time.

Local computing units LCU can be any suitable type of computing device, such as a general-purpose computer, special purpose computer, laptop, local server system, or other suitable computing device. The local computing units LCU may include one or more processor(s) and a memory. The one or more processor(s) may include, for example, one or more central processing units (CPUs), graphics processing units (GPUs), and/or other processing devices. The memory can include one or more computer-readable media and can store information accessible by the one or more processors, including instructions that can be executed by the one or more processors. In particular, this may comprise one or more executables of the application A.

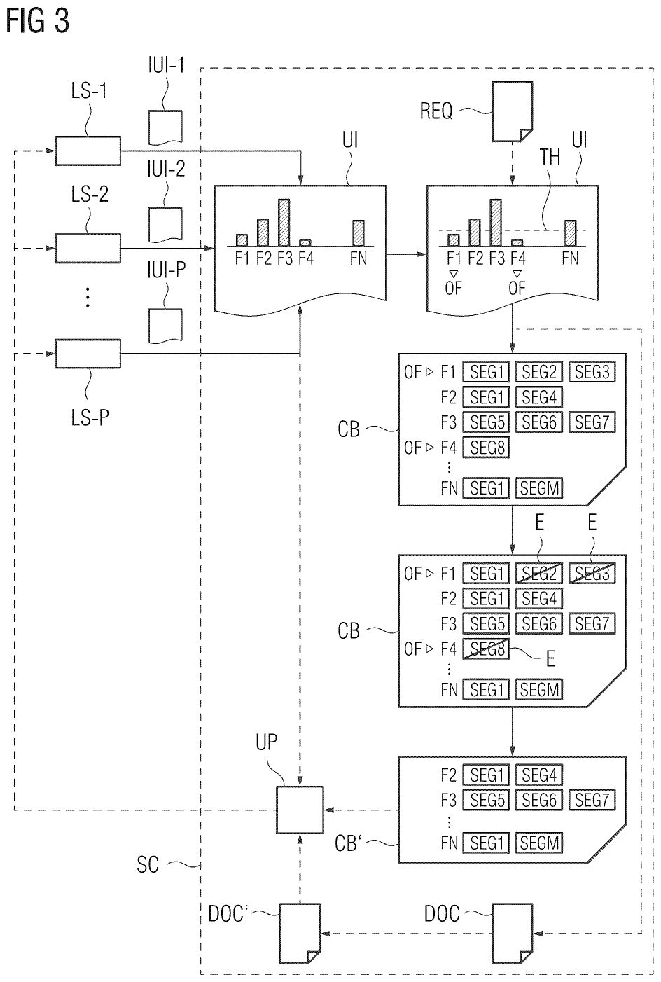

FIG. 2 depicts a method for adapting a code base CB of an application A in a distributed environment. Corresponding data streams are illustrated in FIG. 3. The method comprises several steps. The order of the steps does not necessarily correspond to the numbering of the steps but may also vary between different embodiments of the present invention. Further, individual steps or a sequence of steps may be omitted or repeated.

At step S10, a usage information UI is obtained which indicates how often a certain feature F of the application A is used by the local sites LS-1 . . . LS-P where the application A is deployed.

This may involve collecting individual update information IUI-1 . . . IUI-P from the local sites LS-1 . . . LS-P at optional step S11. The individual update information IUI-1 . . . IUI-P may be requested from the service center SC in regular time intervals and set out how often the features F1 . . . FN were used at the respective LS-1 . . . LS-P within the time interval.

At optional step S12, the individual update information IUI-1 . . . IUI-P may be aggregated into an overarching usage information UI representing the usage of the features F1 . . . FN in the entire distributed system 1.

At step S20, a code base CB of the application A may be obtained. For instance, the version control module VCM may be queried. The code base CB may comprise source code with passages or segments SEG1 . . . SEGM (i.e., SEG1, SEG2, SEG3, SEG4, SEG5, SEG6, SEG7, SEG8, . . . , SEGM) relating to the respective features F1 . . . FN of the application A.

At step S30, the code base is adapted or updated according to the usage information UI.

As a first optional step S31, obsolete features OF may be identified based on the usage information UI. For instance, this may involve applying a predetermined threshold TH to the usage information UI. All features F1 . . . FN which were used to a smaller extent than the threshold TH may be identified as obsolete features at step S31.

At step S32, this information is used to remove or deactivate elements from the code base which relate to the obsolete features OF. This may comprise identifying segments SEG1 . . . SEGM within the code base CB which correspond to the obsolete features OF and checking if they can be removed or deactivated without compromising the functionality of the application. Reasons which could prevent a removal are dependencies amongst the code segments SEG1 . . . SEGM or requirement specifications REQ forbidding the removal of certain features F1 . . . FN. A strategy relying on graph cuts for identifying and removing elements E from the code base CB is explained below in connection with FIG. 5 in more detail.

As an alternative, a large language model may be used for this task. This large language model may be provided at optional step S33. In this regard, off-the-shelf large language models such GPT-4 or the LLaMa2 have proven to be able to deal with source code very efficiently.

At step S34, the large language model is applied. This may involve inputting the code base CB into the large language model with a prompt directed to remove code related to obsolete features OF without compromising the functionality of the remaining features F1 . . . FN.

At optional step S35, a requirement specification REQ is obtained. For instance, individual requirement specifications REQ for the connected local sites LS-1 . . . LS-P may be pulled and aggregated. The requirement specifications REQ may be obtained from the local sites LS-1 . . . LS-P and/or from a data base within the service center SC. Further, the requirement specification REQ may be stored in the version control module VCM.

Optionally, the code base CB from which the obsolete features OF have been removed may additionally be updated from a first version to a second version. This may happen at optional step S36. Accordingly, the adapted code base CB′ may not only have been pruned but also updated. Doing the update after the removal of the obsolete features OF has the advantage that obsolete features OF do not have to be considered in the update.

At step S40, the adapted code base CB′ is provided. This may include entering the adapted code base CB′ in the version control module VCM. Further, this may include providing the adapted code base CB′ for compiling.

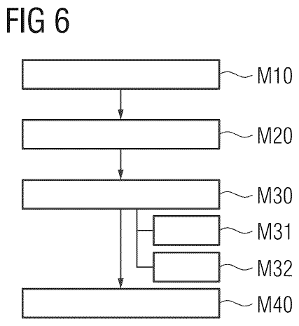

Along those lines, an update package UP may be generated at optional step S50. The update package UP may comprise one or more executables which were generated based on the adapted code base CB′. Further, the update package UP may include a documentation DOC′ generated according to step S70. The update package UP may be uniform for all local sites LS-1 . . . LS-P. According to other examples, the update package may be specifically adapted for the local site LS-1 . . . LS-P based on the respective individual update information IUI-1 . . . IUI-P (c.f., FIG. 6).

At optional step S60, the update package UP is transmitted to the local site LS-1 . . . LS-P. There, the update package UP may be used to locally update the application A at the respective local site LS-1 . . . LS-P.

At optional step S70, an adapted documentation DOC′ is provided which is adapted in accordance with the adapted code base CB′.

This may involve obtaining a previous version of the documentation DOC at the service center SC. For instance, the documentation DOC may be queried from the version control module VCM. The documentation DOC may include a description of the application A with the original feature set F1 . . . FN.

At optional step S72, the documentation DOC may be adapted and brought in line with the adapted code base CB′ and/or the update package UP. In particular, this may involve removing those parts from the documentation DOC which relate to obsolete features OF and/or including an indication which features have been removed as compared to the previous version of the application A. According to some examples, this may involve applying a large language model to the documentation DOC.

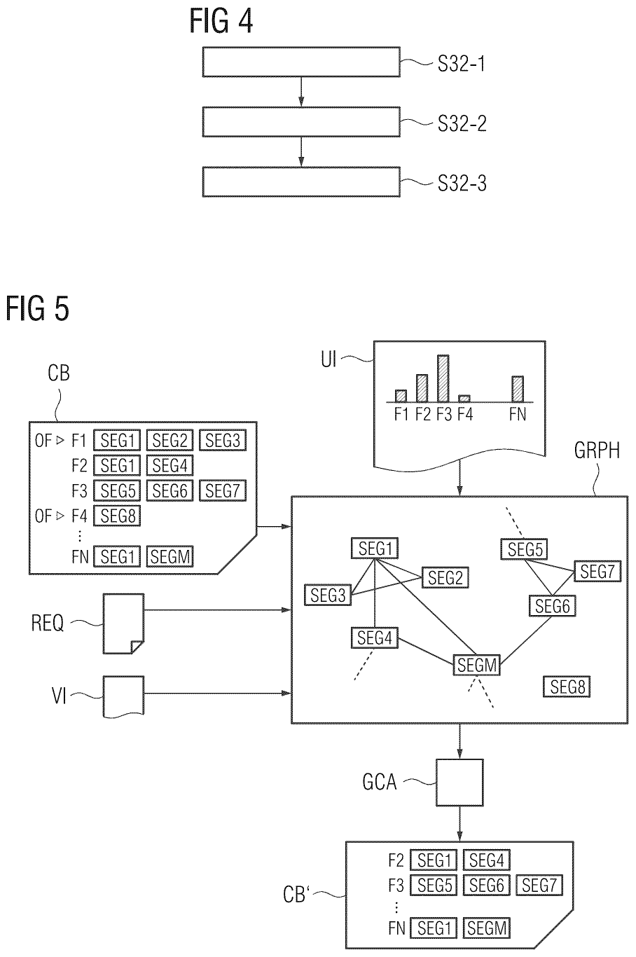

FIG. 4 depicts optional method steps for adapting a code base CB according to a usage information UI. Corresponding data streams are illustrated in FIG. 5. The order of the steps does not necessarily correspond to the numbering of the steps but may also vary between different embodiments of the present invention. Further, individual steps or a sequence of steps may be repeated or omitted. The steps S32-1 to S32-3 are optional and may, in particular be included in step S30 or, more specifically, within or in lieu of steps S31 and/or S32 of FIG. 2.

At step S32-1, one or more code segments SEG1 . . . SEGM in the code base CB are identified which relate to the one or more obsolete features OF. This may be performed by applying a large language model to the code base CB with the task of identifying code segments relating to the obsolete features. Alternatively, a version control query may be used which is directed to find the backlog of the obsolete feature OF in the version control history of the application A. According to some examples, the version control query may be input in the version control module VCM. The answer to the version control query may be provided in the form of the versioning information VI. According to some examples, the version control query may be directed to find attached code change sets. In turn, this enables finding the segments SEG1 . . . SEGM in which this code is embedded.

In a complex code base CB, it is likely that the segments SEG1 . . . SEGM identified at step S32-1 are dependent on other segments SEG1 . . . SEGM of the code base CB which relate to features F1 . . . FN which are still in use or otherwise required and which must not be removed from the code base CB. To ensure the proper functioning of the application A, these dependencies should be considered. To do so, a dependency information GRPH is obtained at step S32-2 which encodes how one or more code segments SEG1 . . . SEGM depend on one another in the code base CB. According to some examples, this may be done by identifying dependencies by searching the code base CB, test code, off-the-shelf-software plugins, and/or documentations (or, in other words, the versioning information VI). According to some examples, this may be performed by a large language model.

As shown in FIG. 5, the dependency information GRPH may be provided in the form of a dependency graph GRPH. The dependency graph may be a directed graph with the segments SEG1 . . . SEGM as nodes and the dependencies as edges. In addition, the dependency graph GRPH may comprise the usage information UI for each segment SEG1 . . . SEGM. Thereby, the usage information UI may be accorded to the segments SEG1 . . . SEGM based on the link between the features F1 . . . FN and the segments SEG1 . . . SEGM as identified at step S31-1. Specifically, each segment SEG1 . . . SEGM may be accorded with the usage number of the feature F1 . . . FN it corresponds to—with the provision to use the highest usage number if a segment SEG1 . . . SEGM is used by more than one feature F1 . . . FN. Including the usage information UI in the dependency graph GRPH may have the advantage that it can intrinsically be considered by graph processing algorithms to optimize the graph in the sense of minimizing unused or seldomly used segments SEG1 . . . SEGM. According to some examples, the usage information UI may be encoded as weights in the dependency graph GRPH. Segments SEG1 . . . SEGM relating to features F1 . . . FN which are required based on a requirement specification REQ may conveniently be set to highest usage numbers (independent of their actual usage).

Step S32-3 comprises applying a graph cut (optimization) algorithm to the dependency graph GRPH. Graph cut optimization is a combinatorial optimization method applicable to a family of functions of discrete variables, involving the concept of cut in the theory of flow networks. Conceptually, this may comprise defining a function f with the usage numbers as variables and iteratively partition the dependency graph GRPH in connected components with the goal to find a local optimum of the function f, the so-called minimum cut. This implements the max-flow min-cut theorem, according to which determining the minimum cut over a graph representing a flow network is equivalent to computing the maximum flow over the network. Specifically, one of the various algorithms developed for such tasks may be used, such as the Ford-Fulkerson, Edmonds-Karp, or Boykov-Kolmogorov algorithm. The code segments SEG1 . . . SEGM thus identified in step S32-3 may constitute the elements E which are to be removed in step S32.

FIG. 6 depicts a method for providing an update package UP for updating an application A deployed at a local site LS-1 . . . LS-P. The order of the steps does not necessarily correspond to the numbering of the steps but may also vary between different embodiments of the present invention. Further, individual steps or a sequence of steps may be omitted or repeated.

The method of FIG. 6 may be applied as a stand-alone process. According to some examples, steps of FIG. 6 may connect to the steps outlined in connection with FIGS. 2 to 5. For instance, steps of FIG. 6 may be executed within steps S50 or S60 of FIG. 2.

At step M10, an individual usage information IUI-1 of an individual local site LS-1 may be obtained substantially as outlined in connection with step S11.

At step M20, a code base CB, CB′ of the application A is obtained. According to some examples, this may be the adapted code base CB′ which was adapted and provided as outlined in connection with steps S30 and S40 of FIG. 2. However, this is not required as the ensuing steps are applicable to any code base CB. Generally, a code base CB may be obtained as described in connection with step S20.

At step M30, the individual usage information IUI-1 is used to generate an update package UP based on the code base CB, CB′ which is especially configured for the individual local site LS-1. Generally, producing the update package UP may involve compiling the code base CB as described in connection with step S50.

To configure the update package UP for the individual local site LS-1, features OF may be identified which became obsolete for the usage of the application A at the individual local site LS-1. As explained in connection with step M31, this may involve comparing usage numbers to a predetermined threshold TH. Code related to obsolete features OF may not be compiled at all upon creating the update package UP for the individual local site LS-1. Alternatively, executables relating to obsolete features OF may be removed from a general update package generated from the code base CB, CB′.

Optionally, the update package UP may comprise an adapted documentation DOC′ which was adapted specifically for the individual local site LS-1 . . . LS-P. The documentation DOC may be adapted at optional step M32. Thereby, step M32 may principally implement the processing of step S72 of FIG. 2.

At step M40, the update package UP may be transmitted to the individual local site LS-1 where it may be used to update the application A to an updated version.

It will be understood that, although the terms first, second, etc. may be used herein to describe various elements, components, regions, layers, and/or sections, these elements, components, regions, layers, and/or sections, should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

Spatial and functional relationships between elements (for example, between modules) are described using various terms, including “on,” “connected,” “engaged,” “interfaced,” and “coupled.” Unless explicitly described as being “direct,” when a relationship between first and second elements is described in the disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” on, connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Also, the term “example” is intended to refer to an example or illustration.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

It is noted that some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed above. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. The present invention may, however, be embodied in many alternate forms and should not be construed as limited to only the embodiments set forth herein.

In addition, or alternative, to that discussed above, units and/or devices according to one or more example embodiments may be implemented using hardware, software, and/or a combination thereof. For example, hardware devices may be implemented using processing circuitry such as, but not limited to, a processor, Central Processing Unit (CPU), a Graphics Processing Unit (GPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner. Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

Even further, any of the disclosed methods may be embodied in the form of a program or software. The program or software may be stored on a non-transitory computer readable medium and is adapted to perform any one of the aforementioned methods when run on a computer device (a device including a processor). Thus, the non-transitory, tangible computer readable medium, is adapted to store information and is adapted to interact with a data processing facility or computer device to execute the program of any of the above mentioned embodiments and/or to perform the method of any of the above mentioned embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as a computer processing device or processor; however, one skilled in the art will appreciate that a hardware device may include multiple processing elements or processors and multiple types of processing elements or processors. For example, a hardware device may include multiple processors or a processor and a controller. In addition, other processing configurations are possible, such as parallel processors.

The computer programs include processor-executable instructions that are stored on at least one non-transitory computer-readable medium (memory). The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc. As such, the one or more processors may be configured to execute the processor executable instructions.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

Further, at least one example embodiment relates to the non-transitory computer-readable storage medium including electronically readable control information (processor executable instructions) stored thereon, configured in such that when the storage medium is used in a controller of a device, at least one embodiment of the method may be carried out.

The computer readable medium or storage medium may be a built-in medium installed inside a computer device main body or a removable medium arranged so that it can be separated from the computer device main body. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices); volatile memory devices (including, for example static random access memory devices or a dynamic random access memory devices); magnetic storage media (including, for example an analog or digital magnetic tape or a hard disk drive); and optical storage media (including, for example a CD, a DVD, or a Blu-ray Disc). Examples of the media with a built-in rewriteable non-volatile memory, include but are not limited to memory cards; and media with a built-in ROM, including but not limited to ROM cassettes; etc. Furthermore, various information regarding stored images, for example, property information, may be stored in any other form, or it may be provided in other ways.

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Wherever meaningful, individual embodiments or their individual aspects and features can be combined or exchanged with one another without limiting or widening the scope of the present invention. Advantages which are described with respect to one embodiment of the present invention are, wherever applicable, also advantageous to other embodiments of the present invention. Independent of the grammatical term usage, individuals with male, female or other gender identities are included within the term.

What is claimed is:

1. A computer-implemented method for adapting a code base of an application including a plurality of features and which is deployed in a distributed environment, the distributed environment including a service center administrating the application and one or more local sites operating the application, wherein the computer-implemented method comprises:
obtaining, at the service center, usage information indicating a usage of one or more of the plurality of features of the application operated by at least one of the one or more local sites;
obtaining, at the service center, the code base of the application;
generating, at the service center, an adapted code base of the application from the code base and based on the usage information; and
providing the adapted code base.

2. The computer-implemented method according to claim 1, wherein the obtaining of the usage information comprises:
receiving individual usage information for a plurality of local sites, each individual usage information indicating the usage of one or more of the plurality of features of the application at a respective local site of the plurality of local sites; and
aggregating the individual usage information to obtain the usage information.

3. The computer-implemented method according to claim 1, wherein
the application is operated in a first version at at least one local site of the one or more local sites, and
the computer-implemented method further includes
generating, at the service center, an update package for updating the application from the first version to a second version based on the adapted code base, and
transmitting the update package from the service center to the at least one local site.

4. The computer-implemented method according to claim 1, wherein the generating of the adapted code base comprises:
identifying, at the service center, one or more obsolete features of the plurality of features based on the usage information; and
at least one of removing or deactivating, from the code base, elements relating to the one or more obsolete features to generate the adapted code base.

5. The computer-implemented method according to claim 4, wherein the generating of the adapted code base further comprises:
identifying, in the code base, one or more code segments corresponding to the one or more obsolete features; and
determining dependency information indicating a dependency of the one or more code segments from other code segments in the code base; wherein
the at least one of removing or deactivating is based on the dependency information.

6. The computer-implemented method according to claim 5, wherein
the determining of the dependency information includes generating a dependency graph of code segments in the code base; and
the at least one of removing or deactivating includes applying a graph cut algorithm to the dependency graph to identify the elements to be at least one of removed or deactivated.

7. The computer-implemented method according to claim 4, wherein the generating of the adapted code base comprises:
providing a large language model configured to at least one of
identify, in the code base of the application, elements relating to a feature of the application, or
at least one of remove or deactivate, from the code base of the application, elements relating to the feature of the application, and
applying the large language model to the code base based on the one or more obsolete features to at least one of remove or deactivate elements from the code base relating to the one or more obsolete features.

8. The computer-implemented method according to claim 1, further comprising:
obtaining, at the service center, documentation of the application including natural language text describing one or more features encoded in the code base;
adapting, at the service center, the documentation to generate adapted documentation according to the adapted code base; and
providing the adapted documentation.

9. The computer-implemented method according to claim 1, further comprising:
obtaining, at the service center, a requirement specification identifying one or more required features, wherein
the generating of the adapted code base is further based on the requirement specification.

10. The computer-implemented method according to claim 1, wherein the application is configured to handle medical data and the plurality of features respectively relate to functions for processing the medical data.

11. A computer-implemented method for providing an update-package for updating an application including a plurality of features from a first version to a second version at a local site in a distributed environment, the distributed environment including a service center and one or more local sites, wherein the computer-implemented method comprises:
receiving, at the service center from at least one local site of the one or more local sites, individual usage information indicating a usage of one or more of the plurality of features of the application running in the first version at the at least one local site;
obtaining, at the service center, a code base for updating the application from the first version to the second version;
generating, at the service center, the update-package from the code base based on the individual usage information; and
transmitting the update-package from the service center to the at least one local site.

12. The computer-implemented method according to claim 11, wherein the generating the update-package comprises:
identifying, at the service center, one or more obsolete features of the plurality of features based on the individual usage information; and
generating the update-package by removing, from the code base, elements relating to the one or more obsolete features.

13. The computer-implemented method according to claim 11, further comprising:
obtaining, at the service center, documentation including natural language text relating to the application in the second version; and wherein
the generating the update-package includes adapting the documentation based on the individual usage information to generate adapted documentation for the application according to the second version for the at least one local site, and including the adapted documentation in the update-package.

14. A service center comprising:
at least one processor configured to perform the computer-implemented method of claim 1.

15. A non-transitory computer program product comprising program elements that induce a computing unit of a service center for adapting a code base of an application to perform the computer-implemented method according to claim 1 when the program elements are loaded into a memory of the computing unit.

16. A non-transitory computer-readable medium storing program elements that, when executed by a computing unit of a service center for adapting a code base of an application, cause the service center to perform the computer-implemented method according to claim 1.

17. A service center comprising:
at least one processor configured to perform the computer-implemented method of claim 11.

18. A non-transitory computer-readable medium storing program elements that, when executed by a computing unit of a service center for providing an update-package for updating an application, cause the service center to perform the computer-implemented method according to claim 11.

19. The computer-implemented method according to claim 2, wherein
the application is operated in a first version at at least one local site of the one or more local sites, and
the computer-implemented method further includes
generating, at the service center, an update package for updating the application from the first version to a second version based on the adapted code base, and
transmitting the update package from the service center to the at least one local site.

20. The computer-implemented method according to claim 19, wherein the generating of the adapted code base comprises:
identifying, at the service center, one or more obsolete features of the plurality of features based on the usage information; and
at least one of removing or deactivating, from the code base, elements relating to the one or more obsolete features to generate the adapted code base.
